(19) United States
(12) Patent Application Publication
(10) Pub. No.: US 2020/0189737 A1
(43) Pub. Date: Jun. 18, 2020

(54) POWER DEVICE, AND SINGLE-ROTOR UNMANNED AERIAL VEHICLE

(71) Applicant: SZ DJI TECHNOLOGY CO., LTD., Shenzhen (CN)

(72) Inventors: Jiajing LIM, Shenzhen (CN); Yihan LIU, Shenzhen (CN); Feng LIU, Shenzhen (CN)

(21) Appl. No.: 16/800,912

(22) Filed: Feb. 25, 2020

Related U.S. Application Data
(63) Continuation of application No. PCT/CN2017/099992, filed on Aug. 31, 2017.

(51) Int. Cl. B64C 39/02; B64C 27/20; B64C 3/00

(52) U.S. Cl. CPC B64C 39/024; B64C 27/20; B64C 2201/162; B64C 2201/024; B64C 2201/108; B64C 3/00

(57) ABSTRACT

A propulsion device and a single-rotor unmanned aerial vehicle are provided. The propulsion device includes a duct, a main rotor, and at least two grid wings. The main rotor is located in the duct and is configured to drive fluid to flow in the duct to generate power. The at least two grid wings are located on a side of the main rotor, and a grid wing has a plurality of grid walls spaced apart and extended along an axial direction of the duct. Two side edges of a predetermined cross section of each grid wall have different shapes to generate a lift force under a pressure difference of the fluid flowing through the grid wing. The grid wing is configured to form a torque opposite to a torque of the main rotor under the lift force.

### CROSS-REFERENCE TO RELATED APPLICATION

This application is a continuation of International Application No. PCT/CN2017/099992, filed on Aug. 31, 2017, the entirety of which is incorporated herein by reference.

### TECHNICAL FIELD

The present disclosure generally relates to the field of aircraft and, more particularly, relates to a power device/propulsion device and a single-rotor unmanned aerial vehicle.

### BACKGROUND

Automatic devices, e.g., unmanned aerial vehicles, have been increasingly used. At present, the unmanned aerial vehicle often relies on a power device or a propulsion device (e.g., including a propeller), to generate a lift force for the unmanned aerial vehicle to perform flight and attitude adjustments. When rotating, the propeller will generate a torque opposite to a body of the unmanned aerial vehicle. To prevent the unmanned aerial vehicle from being affected by the torque of the propeller, the unmanned aerial vehicle often has a plurality of rotors, and the rotors are symmetrically arranged on different positions of the unmanned aerial vehicle. Therefore, the torques of different propellers cancel each other. The unmanned aerial vehicle is often provided with four or more rotors.

However, because the unmanned aerial vehicle adopts a multi-rotor mode, the unmanned aerial vehicle has a substantially large volume and weight. This is inconvenient for transportation. The disclosed propulsion device and single-rotor unmanned aerial vehicle are directed to solve one or more problems set forth above and other problems.

### SUMMARY

One aspect of the present disclosure provides a propulsion device. The propulsion device includes a duct, a main rotor, and at least two grid wings. The main rotor is located in the duct and is configured to drive fluid to flow in the duct to generate power. The at least two grid wings are located on a side of the main rotor, and a grid wing has a plurality of grid walls spaced apart and extended along an axial direction of the duct. Two side edges of a predetermined cross section of each grid wall have different shapes to generate a lift force under a pressure difference of the fluid flowing through the grid wing. The grid wing is configured to form a torque opposite to a torque of the main rotor under the lift force.

Another aspect of the present disclosure provides a single-rotor unmanned aerial vehicle. The single-rotor unmanned aerial vehicle includes a body and a propulsion device. The propulsion device includes a duct, a main rotor, and at least two grid wings. The main rotor is located in the duct and is configured to drive fluid to flow in the duct to generate power. The at least two grid wings are located on a side of the main rotor, and a grid wing has a plurality of grid walls spaced apart and extended along an axial direction of the duct. Two side edges of a predetermined cross section of each grid wall have different shapes to generate a lift force under a pressure difference of the fluid flowing through the grid wing. The grid wing is configured to form a torque opposite to a torque of the main rotor under the lift force.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a schematic diagram of an exemplary propulsion device consistent with disclosed embodiments of the present disclosure;

FIG. 2 illustrates a front view of an exemplary propulsion device consistent with disclosed embodiments of the present disclosure;

FIG. 3 illustrates a cross-sectional view along a line ‘A-A’ in FIG. 2;

FIG. 4 illustrates a top view of an exemplary propulsion device consistent with disclosed embodiments of the present disclosure;

FIG. 5 illustrates a schematic force diagram of an exemplary propulsion device consistent with disclosed embodiments of the present disclosure;

FIG. 6 illustrates a schematic diagram of an exemplary grid wing in a first rotation position consistent with disclosed embodiments of the present disclosure;

FIG. 7 illustrates a schematic diagram of an exemplary propulsion device with a grid wing in a first rotation position consistent with disclosed embodiments of the present disclosure;

FIG. 8 illustrates a schematic force diagram of an exemplary propulsion device with a grid wing in a first rotation position consistent with disclosed embodiments of the present disclosure;

FIG. 9 illustrates a schematic diagram of an exemplary grid wing in a second rotation position consistent with disclosed embodiments of the present disclosure;

FIG. 10 illustrates a schematic diagram of an exemplary propulsion device with a grid wing in a second rotation position consistent with disclosed embodiments of the present disclosure;

FIG. 11 illustrates a schematic diagram of a predetermined cross section of an exemplary grid wall consistent with disclosed embodiments of the present disclosure;

FIG. 12 illustrates a schematic diagram of an exemplary grid wing consistent with disclosed embodiments of the present disclosure;

FIG. 13 illustrates a schematic diagram of another exemplary grid wing consistent with disclosed embodiments of the present disclosure;

FIG. 14 illustrates a schematic diagram of an exemplary grid wing with an external structure consistent with disclosed embodiments of the present disclosure;

FIG. 15 illustrates a schematic diagram of another exemplary grid wing with an external structure consistent with disclosed embodiments of the present disclosure;

FIG. 16 illustrates a schematic diagram of another exemplary grid wing with an external structure consistent with disclosed embodiments of the present disclosure;

FIG. 17 illustrates a schematic diagram of another exemplary grid wing with an external structure consistent with disclosed embodiments of the present disclosure;

FIG. 18 illustrates a schematic diagram of an exemplary control mechanism of a grid wing consistent with disclosed embodiments of the present disclosure;

FIG. 19 illustrates a schematic diagram of another exemplary control mechanism of a grid wing consistent with disclosed embodiments of the present disclosure; and

FIG. 20 illustrates a schematic diagram of an exemplary single-rotor unmanned aerial vehicle consistent with disclosed embodiments of the present disclosure.

### DETAILED DESCRIPTION OF THE DISCLOSURE

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

Similar reference numbers and letters represent similar terms in the following Figures, such that once an item is defined in one Figure, it does not need to be further discussed in subsequent Figures.

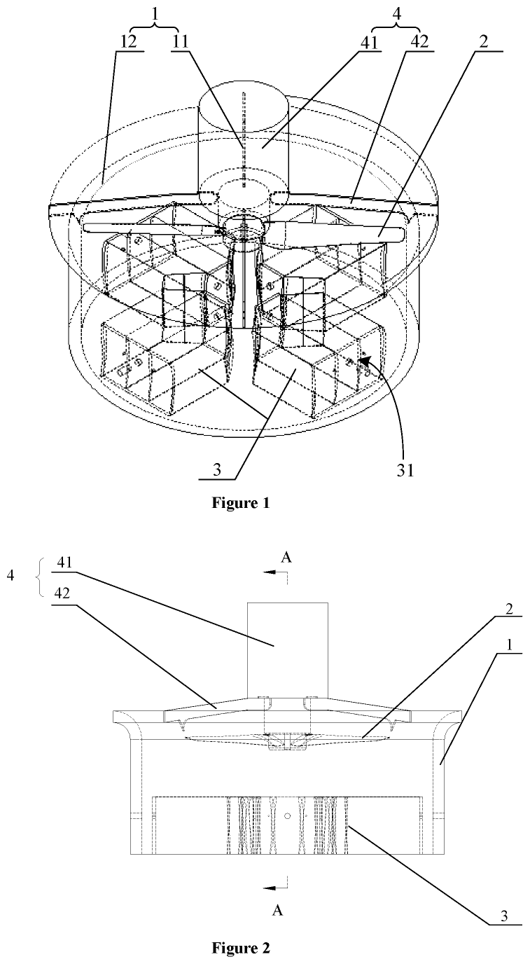

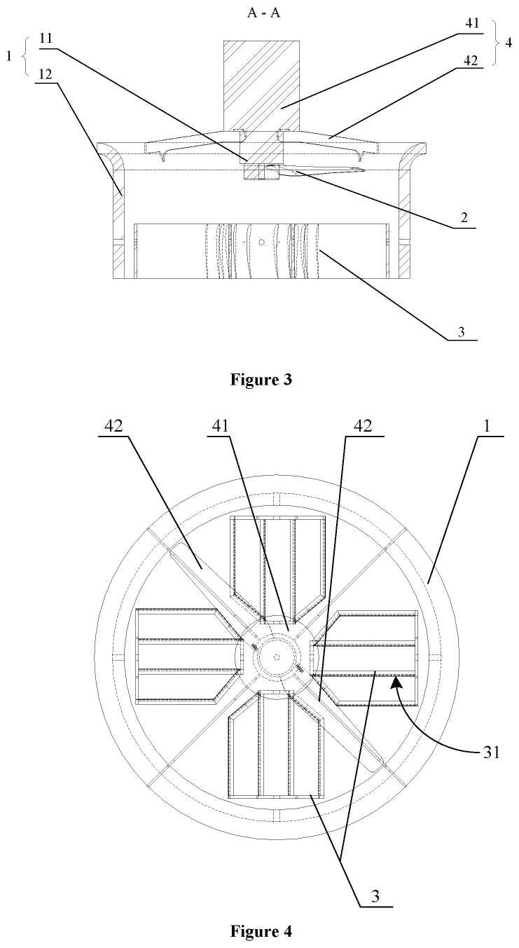

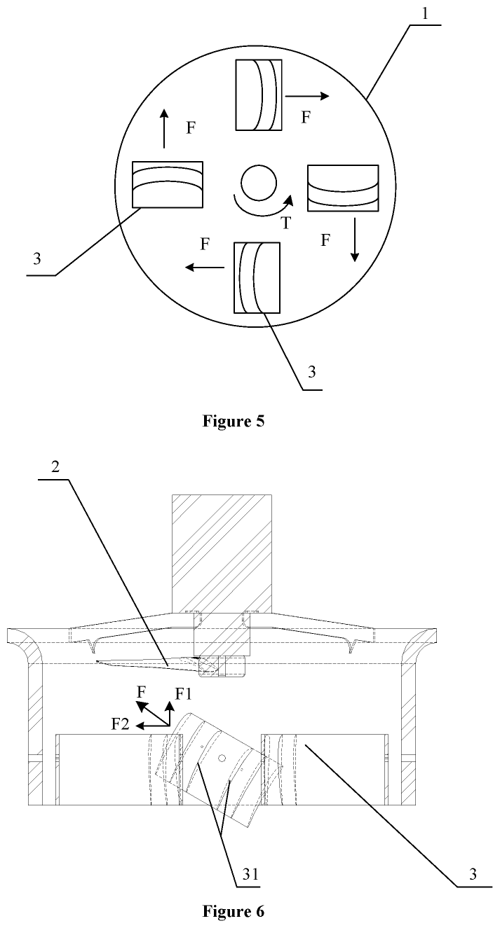

The present disclosure provides a propulsion device. FIG. 1 illustrates a schematic diagram of a propulsion device consistent with disclosed embodiments of the present disclosure. FIG. 2 illustrates a front view of a propulsion device consistent with disclosed embodiments of the present disclosure, and FIG. 3 illustrates a cross-sectional view along a line ‘A-A’ in FIG. 2. FIG. 4 illustrates a top view of a propulsion device consistent with disclosed embodiments of the present disclosure. FIG. 5 illustrates a schematic force diagram of a propulsion device consistent with disclosed embodiments of the present disclosure. Referring to FIGS. 1-5, the propulsion device provided in the disclosed embodiments may be mainly applied to an aircraft or an underwater vehicle, etc. In various embodiments, unless otherwise specified, the terms “propulsion device” and “power device” may be interchangeably used.

The propulsion device may include a duct 1, a main rotor 2 and at least two grid wings 3. The main rotor 2 may be located in the duct 1 and may be arranged coaxially with the duct 1. The main rotor 2 may be configured to drive fluid to flow in the duct 1 to generate a power. The grid wings 3 may be located on a side of the main rotor 2. The grid wing 3 may include a plurality of grid walls 31 spaced apart and extended along an axial direction of the duct 1. Two side edges of a predetermined cross section of each grid wall 31 may have different shapes, therefore the two side edges of the predetermined cross section may generate a lift force under the pressure difference of the fluid flowing through the grid wing 3. The grid wing 3 may be configured to form a torque opposite to a torque T of the main rotor 2 under the lift force.

The main rotor 2 of the propulsion device may be disposed in the duct 1, and a rotation axis direction of the main rotor 2 may be the same as the axial direction of the duct 1. Because the duct 1 is provided on an outer side of the main rotor 2, the airflow or liquid flow at the wing tip of the main rotor 2 may be blocked by an inner wall of the duct 1, thereby improving the utilization efficiency of fluid, and generating a substantially large thrust. The main rotor 2 may be driven by a power source, e.g., a motor, to rotate, and may use a paddle to drive the fluid to flow in the duct 1. When flowing, the fluid may provide a power, and the propulsion device may move in an opposite direction under the counterforce of the fluid.

In one embodiment, the fluid driven by the main rotor 2 may be a gas such as air, or a liquid such as water. In view of this, the propulsion device may move under the force of air or water. Correspondingly, the main rotor 2 may select a corresponding airfoil according to the fluid type. For illustrative purposes, unless otherwise specified, in the disclosed embodiments, the fluid may be air as an example for description, and correspondingly, the propulsion device may be disposed on an aircraft, etc.

Because the propulsion device has one main rotor 2, when rotating around the rotation axis, the main rotor 2 may generate a torque T opposite to the rotation direction thereof for the propulsion device, and the propulsion device may have a tendency to rotate around the rotation axis under the torque T. In other words, the entire propulsion device may have a tendency to generate rotation. To eliminate the tendency of the propulsion device to rotate, the propulsion device may include at least two grid wings 3. The grid wings 3 may be located on a side of the main rotor 2. In other words, the grid wings 3 and the main rotor 2 may be located at different positions along the axial direction of the rotation axis.

In view of this, when the main rotor 2 rotates, the airflow generated in the duct 1 may pass through the airfoil surface of the grid wing 3. The grid wing 3 may have a plurality of grid walls 31 spaced apart and extended along the direction of the duct 1. Further, the two side edges of the predetermined cross section of each grid wall 31 may have different shapes, e.g., a shape similar to the cross section of a wing of a fixed-wing aircraft. In view of this, when passing through the grid wall 31, the airflow may flow along the edges of the grid wall 31. At the same time, because the two side edges of the predetermined cross section of each grid wall 31 have different shapes, the path of airflow varies.

According to Bernoulli's principle, the airflow flowing through a long path may have a speed faster than the airflow flowing through a short path, and the airflow speed may be inversely proportional to the air pressure. In view of this, the pressure on the two sides of the predetermined cross section may be inconsistent, and the lift force may be generated on the two sides of the predetermined cross section of the grid wall 31 under the pressure difference of the fluid flowing through the grid wing 3. A direction of the lift force may be from the side with high air pressure to the side with low air pressure. In view of this, by setting the orientations of the grid wing 3 and the side edge of the predetermined cross section, the grid wing 3 may generate a torque that intersects or even is perpendicular to the rotation direction of the main rotor 2 under the lift force. The torque generated by the grid wing 3 may be opposite to the torque T of the main rotor 2, such that the propulsion device may be balanced under torques having opposite directions. Therefore, the propulsion device may be prevented from rolling and rotating around the axis due to the torque T of the main rotor 2. Further, the grid wing 3 may be often disposed on downstream or the downwind side of the main rotor 2, such that the grid wing 3 may directly utilize the fluid power from the side of the main rotor 2, and may have a substantially high efficiency.

In view of this, through the shape of the grid wall 31 of the grid wing 3, a torque of the lift force that is capable of balancing the torque T of the main rotor 2 may be generated under the pressure difference of the fluid to enable the entire propulsion device to keep balance. Because the lift force generated by the grid wing 3 originates from the airflow driven by the main rotor 2, when a rotation speed of the main rotor 2 varies and the torque T of the main rotor 2 varies accordingly, the lift force generated by the grid wing 3 may change accordingly due to the change in airflow speed. Therefore, the torque generated by the grid wing 3 under the lift force may always be balanced with the torque T of the main rotor 2 to prevent the propulsion device from rotating, and the propulsion device may maintain a stable attitude.

In one embodiment, the axial direction of the duct 1 may be located in the predetermined cross section of the grid wall 31. In view of this, a cutting direction of the predetermined cross section of the grid wall 31 may be along the axial direction of the duct 1. When passing through the grid wall 31, the airflow in the duct 1 may flow through two side edges of the predetermined cross section and may generate different fluid pressures on the two side edges thereof. The grid wall 31 may generate a lateral lift force under the pressure difference of the fluid. The direction of the lift force may intersect or be perpendicular to the axial direction of the duct 1 to cancel out the torque T of the main rotor 2.

Because the lift force generated by the grid wing 3 is lateral, to enable the torque of the lift force of the grid wing 3 to cancel out the torque T of the main rotor 2, a quantity of the grid wings 3 may be more than one, and the plurality of grid wings 3 may be often arranged at different positions with respect to the rotation axis of the main rotor 2. In one embodiment, the grid wing 3 may be located between the axis center 11 of the duct 1 and the inner wall 12 of the duct 1, and may be arranged centro-symmetrically with respect to the axis center 11. In view of this, the lift force generated by the grid wing 3 under the airflow may point to a side of the axis center 11 of the duct 1, and there may be a distance between the equivalent action point of the lift force on the grid wing 3 and the axis center 11 of the duct 1. In other words, a torque pointing to a side of the axis center 11 of the duct 1 may be generated for the axis center 11 of the duct 1. The torque may be configured to balance and cancel out the torque T of the main rotor 2.

Because the quantity of grid wings 3 is more than one, the overall torque generated by the lift forces of the grid wings 3 may change by setting the quantity of grid wings 3. When the plurality of grid wings 3 are arranged centro-symmetrically with respect to the axis center 11 of the duct 1, the predetermined cross sections of the grid walls 31 of the grid wings 3 may be arranged in a same direction, such that the lift forces generated by the grid wings 3 may generate torques with a same direction. In one embodiment, the torque formed by the lift force generated by the grid wing 3 may have a direction rotating clockwise, or counterclockwise, around the axis center 11 of the duct 1. Correspondingly, when the torque of the lift force generated by the grid wing 3 has a direction rotating clockwise, a matched main rotor 2 may rotate counterclockwise. When the torque of the lift force generated by the grid wing 3 has a direction rotating counterclockwise, a matched main rotor 2 may rotate clockwise.

To dispose the grid wings 3, the propulsion device may further include a connection structure 4. The connection structure 4 may have an axial body 41 suspended over a position of the axis center 11 of the duct 1. The grid wings 3 may be located between the axial body 41 and the inner wall 12 of the duct 1. In view of this, the axial body 41 located at the axis center 11 of the duct 1 may be configured as a mounting seat or a connection point of a structure and a component, e.g., the grid wing 3, or the main rotor 2, etc. To reduce air resistance, the ends and sidewalls of the axial body 41 may often be streamlined.

The axial body 41 may have different axial lengths and sizes. In one embodiment, an axial length of the axial body 41 may be substantially short, and the axial body 41 and the grid wings 3 may be located in different sections of the duct. In another embodiment, the axial length of the axial body 41 may be substantially long, and the grid wings 31 may be located at a side surface of the axial body 41. To facilitate the disposure of the main rotor 2, the axial length of the axial body 41 may often be short, and may often be located at one end of the duct 1. In view of this, the rotation axis of the main rotor 2 may be connected to the axial body 41, and the main rotor 2 may be located between the axial body 41 and the grid wings 3. Therefore, the axial body 41, the main rotor 2 and the grid wings 3 may occupy different sections of the duct, respectively. Further, a motor configured to drive the main rotor 2 to rotate may be disposed on the axial body 41.

Further, the connection structure 4 may further include a connection arm 42 connected between the axial body 41 and the duct 1. The connection arm 42 may fix the axial body 41 at a position of the axis center 11 of the duct 1, to fix and connect the axial body 41 and to avoid the axial body 41 from being in contact with the inner wall 12 of the duct 1. The connection arm 42 may be arranged axi-symmetrically or centro-symmetrically with respect to the axial body 41, to ensure the axial body 41 to be well supported in each direction when the propulsion device is running.

To connect the grid wing 3, at least one of the axial body 41 or the inner wall 12 of the duct 1 may be connected to the grid wing 3. In one embodiment, when the axial body 41 has a substantially long length and extends to a section of the duct where the grid wing 3 is located along the axial direction of the duct 1, a connection and fixing structure may be disposed on the axial body 41 to connect the grid wing 3 and the axial body 41. In another embodiment, when the axial body 41 is substantially short, the connection and fixing structure may be disposed on the inner wall 12 of the duct 1, and the grid wing 3 may be connected to the inner wall 12 of the duct 1. Alternatively, two ends of the grid wing 3 may be connected to the axial body 41 and the inner wall 12 of the duct 1, respectively.

In one embodiment, the grid wing 3 may be rotatably disposed in the duct 1, and a rotation axis of the grid wing 3 may have a direction perpendicular to the axial direction of the duct 1. In view of this, the grid wing 3 may change the direction and magnitude of the lift force by rotating, and correspondingly, may provide a lateral torque or a rotating torque, to achieve the attitude adjustment of the propulsion device.

To facilitate the attitude adjustment of the propulsion device through the rotation of the grid wing 3, at least three grid wings 3 may be provided, and the grid wings 3 may be arranged in a same plane perpendicular to the axial direction of the duct 1. In view of this, the plurality of grid wings may together provide a torque for cancelling out the torque T of the main rotor 2. Because the grid wings 3 have a substantially large quantity, the direction and angle of the lift force may be changed by controlling one or more grid wings to rotate, to achieve the attitude adjustment of the propulsion device. The remaining grid wings may still provide a certain anti-rotation torque for the propulsion device. At the same time, because the grid wings 3 are disposed in the same plane perpendicular to the axis of the duct 1, when a grid wing 3 rotates, the lift force thereof may cause an angular deflection with respect to such plane, and may not form a torque outside such plane with lift forces of the other grid wings. Therefore, when the grid wing 3 rotates, the change in torque may be substantially simple, and may be easily controlled.

When being desired to use the grid wing 3 to adjust the attitude of the propulsion device, to facilitate control, in one embodiment, the quantity of the grid wings 3 may be four, and the grid wings 3 may be mutually oppositely disposed in the duct 1 with respect to the axis center 11 of the duct 1. The grid wings 3 may be arranged in four mutually orthogonal directions in the plane, respectively. In view of this, when being viewed from a direction perpendicular to the axial direction of the duct 1, the four grid wings 3 may form a cross shape. Because the four grid wings 3 are mutually orthogonal to each other, when the two mutually opposed grid wings 3 rotate together, the lift force may be provided from two mutually orthogonal directions, and may cause the propulsion device to rotate under the torque of the lift force. In view of this, by setting the position and direction of the grid wing 3, when the grid wing 3 rotates, the generated lift force may drive the propulsion device to rotate around the pitch axis, yaw axis, or roll axis, thereby achieving the attitude adjustment of the propulsion device.

In one embodiment, when deflecting the lift force by rotating the grid wing 3 and forming the torque for adjusting the attitude of the propulsion device, the four grid wings may have at least one pair of grid wings that are capable of being rotated with respect to the plane on which the grid wings 3 are located. When the grid wing 3 rotates, the direction of lift force of the grid wing 3 may have an angle with respect to the plane on which the four grid wings 3 are located. Therefore, a deflected force may be provided to cause the propulsion device to rotate under the deflected torque.

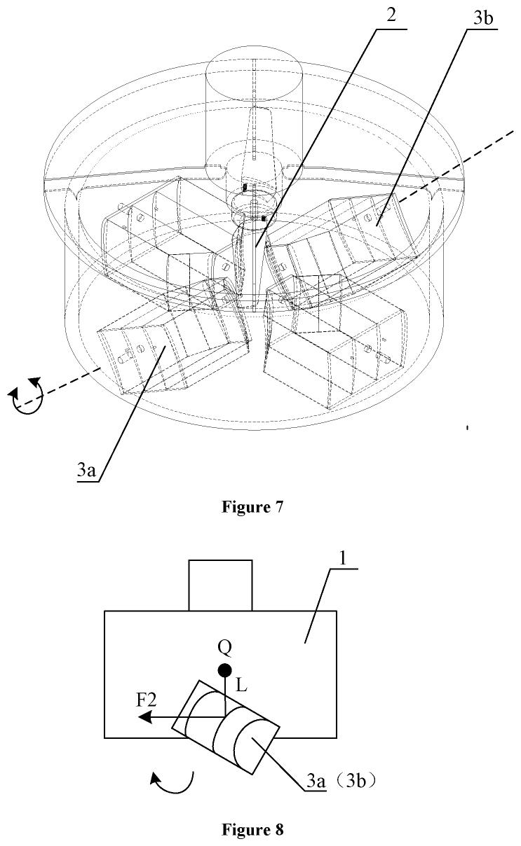

Further, when the rotated grid wings in the four grid wings 3 are different, the rotating effect of the propulsion device may be different. FIG. 6 illustrates a schematic diagram of a grid wing in a first rotation position consistent with disclosed embodiments of the present disclosure. FIG. 7 illustrates a schematic diagram of a propulsion device with a grid wing in a first rotation position consistent with disclosed embodiments of the present disclosure. FIG. 8 illustrates a schematic force diagram of a propulsion device with a grid wing in a first rotation position consistent with disclosed embodiments of the present disclosure.

Referring to FIGS. 6-8, when the four grid wings 3 have a pair of grid wings 3a and 3b rotated with respect to the plane on which the four grid wings 3 are located, the direction of the lift force F provided by the grid wings 3a and 3b may be deflected accordingly, and may be tilted toward a side of the axial direction of the duct 1 from the original direction perpendicular to the axial direction of the duct 1. In view of this, the lift force generated by the rotated grid wings 3a and 3b may be decomposed into a vertical component force F1 along the axial direction of the duct 1 and a lateral component force F2 perpendicular to the axial direction of the duct 1. Because there is often a spacing L between the plane on which the grid wings 3 are located and the center of gravity Q of the entire aircraft, the lateral component force F2 may generate a lateral torque with respect to the center of gravity Q, thereby driving the propulsion device to rotate around a first axis. The first axis may be parallel to the rotation axes of the grid wings 3a and 3b, and the first axis may pass through the position of the center of gravity of the propulsion device or the entire aircraft.

Further, the grid wings 3a and 3b rotated with respect to the plane on which the grid wings 3 are located may be disposed in a direction along a head-tail connection direction of the entire aircraft, i.e., a normal flight direction of the aircraft, or in a direction perpendicular to the head-tail connection direction of the aircraft. When the grid wings 3a and 3b disposed in the direction along the head-tail connection direction of the aircraft rotate, the propulsion device may rotate around the head-tail connection direction to achieve attitude adjustment rotated around the roll axis. When the grid wings 3a and 3b disposed in the direction perpendicular to the head-tail connection direction of the aircraft rotate, the propulsion device may rotate around the pitch axis to achieve attitude adjustment rotated around the pitch axis.

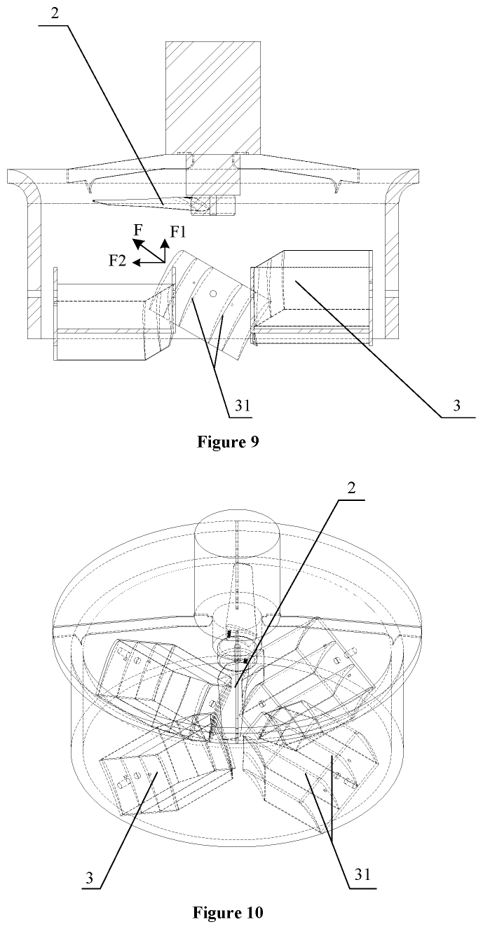

FIG. 9 illustrates a schematic diagram of a grid wing in a second rotation position consistent with disclosed embodiments of the present disclosure. FIG. 10 illustrates a schematic diagram of a propulsion device with a grid wing in a second rotation position consistent with disclosed embodiments of the present disclosure. Referring to FIG. 9 and FIG. 10, when the four grid wings 3 have two pairs of grid wings rotated with respect to the plane on which the grid wings are located, in view of this, the lift forces F of the four grid wings 3 may be tilted toward a same direction, and correspondingly, may be divided into component forces in different directions. Because the four grid wings 3 are mutually symmetrically arranged, the lateral component forces F2 of the lift forces F of the grid wings 3 in the direction perpendicular to the axial direction of the duct 1 may cancel each other. However, in view of this, because the lift force F is divided into various component forces in different directions, the torque that was originally used to cancel out the torque T of the main rotor 2 may decrease, and the propulsion device may rotate around the axis of the duct 1 under the difference of the torque generated by the grid wings 3 and the torque T of the main rotor 2, to achieve the attitude adjustment operation around the yaw axis.

In view of this, when four grid wings 3 are provided in the propulsion device, each pair of the four grid wings 3 may rotate with respect to the plane on which the four grid wings are located. Therefore, torques in different directions may be generated relying on the change in the direction of the lift force, to enable the propulsion device to achieve the attitude adjustment operation rotated around the pitch axis, roll axis or yaw axis.

To drive the grid wing 3 to rotate, the propulsion device may further include a grid wing driver (not illustrated) for driving the grid wing 3 to rotate to different angles. The grid wing driver may include a motor, and a transmission mechanism connected between the motor and the grid wing 3, etc. To reduce weight and space occupation, the grid wing driver may include one motor, and the motor may achieve a transmission connection with each grid wing 3 through the transmission mechanism. In certain embodiments, each grid wing 3 may be provided with an independent motor for driving.

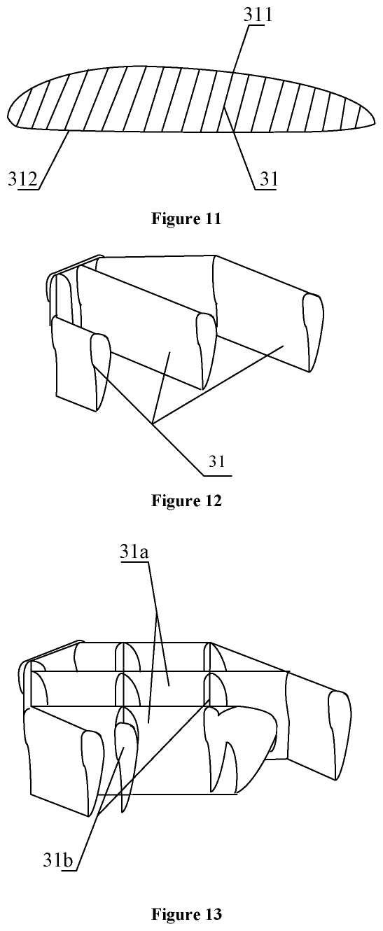

To generate the lift force by the air pressure difference between the two sides of the grid wing, the predetermined cross section of the grid wall 31 in the grid wing 3 may have a corresponding shape. FIG. 11 illustrates a schematic diagram of a predetermined cross section of a grid wall consistent with disclosed embodiments of the present disclosure. Referring to FIG. 11, in one embodiment, the two side edges of the predetermined cross section of the grid wall 31 each may have a convex arc shape, and the two side edges may have different radians to enable the fluid flowing through the grid wing 3 to generate a pressure difference on the two side edges. In view of this, the predetermined cross section of the grid wall 31 may have a similar shape as the cross section of a wing of a fixed-wing aircraft, and each may have a streamlined edge with a substantially small radian on one side and a substantially large radian on the other side.

When flowing through the grid wall 31, the airflow may first flow through the two side edges, and may meet at the junction between the two side edges. When the airflow flows through a flat side edge with a substantially small radian, the path of the side edge may be substantially short, the airflow speed may be substantially low, and the pressure may be substantially large. When the airflow flows through the side edge with a substantially large radian, the path of the side edge may be substantially long, the airflow speed may be substantially high accordingly, and the airflow pressure may be substantially small. In view of this, under pressure on the two sides of the predetermined cross section, the grid wall 31 may be subjected to a lift force toward the side edge with a substantially large radian.

Further, the two side edges of the predetermined cross section may include a first edge 311 and a second edge 312. A convex direction of the first edge 311 may be the same as the rotation direction of the main rotor 2. A convex direction of the second edge 312 may be opposite to the rotation direction of the main rotor 2. The first edge 311 may have a radian greater than the second edge 312. Because the radian of the first edge 311 is greater than the radian of the second edge 312, the direction of the lift force received by the grid wall 31 may be the same as the convex direction of the first edge 311, thereby forming a torque in the direction of the lift force for the propulsion device. When the direction of the lift force is the same as the rotation direction of the main rotor 2, because the rotation torque of the main rotor 2 to the propulsion device is opposite to the rotation direction of the main rotor 2, the direction of the torque formed by the lift force of the grid wall 31 may be opposite to the rotation torque of the main rotor 2 to the propulsion device. Therefore, the torque received by the grid wall 31 may cancel out the torque of the main rotor 2 to the propulsion device, thereby preventing the propulsion device from rotating under the torque T.

In addition, the two side edges of the predetermined cross section may have any other suitable shape. In one embodiment, one side may have a flat shape, and the other side may have an arc shape. In certain embodiments, as long as the shapes of the two side edges of the predetermined cross section are capable of enabling airflow flowing through the two side edges to generate a pressure difference, and the shape of the side edge does not cause too much obstruction to the normal flow of the airflow, the two side edges may have any other suitable cross-sectional shapes that are capable of generating the lift force known to those skilled in the art, which are not repeated herein.

To improve the utilization efficiency of the lift force of the grid wall 31, the lift force generated by a single grid wall 31 may be fully used to cancel out the torque T of the main rotor 2, and the grid walls 31 in each grid wing 3 may be arranged parallel to each other along a radial direction of the duct 1. In view of this, the direction of the lift force generated by the grid wall 31 may be perpendicular to the radial direction of the duct 1. Therefore, the torque generated by the grid wall 31 with respect to the axis center of the duct 1 may be substantially large, which may improve the aerodynamic efficiency of a single grid wall 31, and may reduce the quantity and the outer dimensions of the grid wall 31.

Similarly, in a case where the layout space of the grid wing 3 is limited, to increase the lift force of the grid wing 3 without increasing the size of the grid wing 3, each grid wing 3 may include a plurality of grid walls 31. The lift forces of the plurality of grid walls 31 may be superimposed as the overall lift force of the grid wing 3, such that the lift force of the grid wing 3 may meet the requirements.

FIG. 12 illustrates a schematic diagram of a grid wing consistent with disclosed embodiments of the present disclosure. Referring to FIG. 12, as an arrangement manner of the grid wing 3, each grid wing 3 may include at least three grid walls 31 arranged in parallel with each other. In view of this, each grid wall 31 in the grid wing 3 may provide a certain lift force, and the lift forces provided by the plurality of grid walls 31 may be superimposed on each other. Therefore, even if a single grid wing 3 has a substantially small airfoil area, the single grid wing 3 may provide a substantially large lift force to cancel out the torque of the main rotor 2. To ensure the superimposing effect of the lift forces, the plurality of grid walls 31 may be parallel to each other, such that the lift forces provided by the grid walls 31 may have a same direction, and the superimposed lift force may be substantially large.

FIG. 13 illustrates a schematic diagram of another grid wing consistent with disclosed embodiments of the present disclosure. Referring to FIG. 13, as another arrangement manner of the grid wing 3, the grid walls 31 in each grid wing 3 may be arranged obliquely with respect to the radial direction of the duct 1, and the grid walls 31 in each grid wing 3 may be staggered with each other. In view of this, the grid walls 31 in each grid wing 3 each may have a certain angle with respect to the radial direction of the duct 1, and may provide a certain component force in a direction perpendicular to the radial direction of the duct 1. The superimposed component forces of the plurality of grid walls 31 may be used as the lift force provided by the grid wing 3.

In one embodiment, when the grid walls 31 in the grid wing 3 are staggered with each other and are arranged obliquely with respect to the radial direction of the duct 1, the grid wall 31 in each grid wing 3 may include a plurality of first grid walls 31a arranged along a first direction and parallel to each other, and a plurality of second grid walls 31b arranged along a second direction and parallel to each other. The first grid walls 31a and the second grid walls 31b may be staggered with each other, and the first direction may be different from the second direction.

In view of this, the first grid walls 31a and the second grid walls 31b that are staggered with each other may form a grid-like structure, and each grid in the grid-like structure may have a quadrangular shape. When flowing through the grid walls, the airflow may generate a lift force perpendicular to the edge. Because the shapes of the four edges of the grid are often symmetrical with each other, a part of the component forces in the lift force may be partially cancelled out, and the component forces in a same direction may be retained. The component forces in a same direction may be superimposed to form the lift force of the grid wing. Further, the first direction may be perpendicular to the second direction.

To improve the airflow condition on the grid wall 31 and to strengthen the structural strength of the grid wall 31, each grid wing 3 may further include an outer frame 32. The outer frame 32 may surround the outer side of the grid wall 31. The outer frame 31 may reduce the interference of the external airflow on the grid wall 31, thereby ensuring the grid wall 31 in the grid wing 3 to provide a sufficient lift force. At the same time, the disturbance caused by the airflow may be reduced, and the structural strength and reliability of the grid wing 3 may be improved.

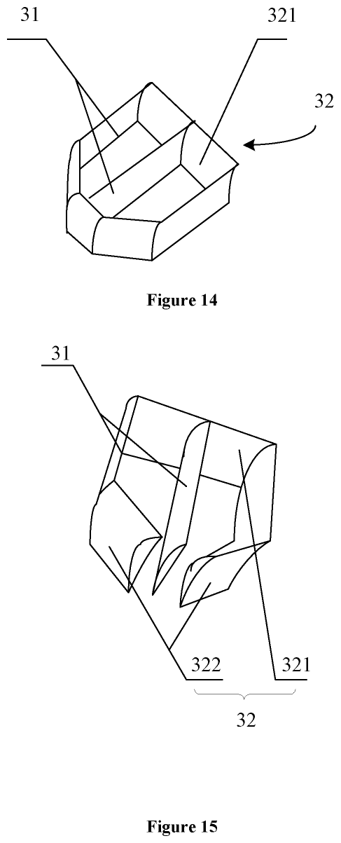

Further, the outer frame 32 may have a variety of different shapes and styles. In one embodiment, FIG. 14 illustrates a schematic diagram of a grid wing with an external structure consistent with disclosed embodiments of the present disclosure. Referring to FIG. 14, the outer frame 32 may include a first baffle 321. The first baffle 321 may be located on a side of the grid wing 3 close to the inner wall 12 of the duct 1. One end of the grid wall 31 close to the inner wall 12 of the duct 1 may be connected to the first baffle 321. The first baffle 321 may be disposed at the end of the grid wall 31 close to the inner wall 12 of the duct 1. The first baffle 321 may block the airflow and may prevent the airflow from flowing out along the end of the grid wall 31, thereby ensuring the airflow flowing through the grid wing 3 to be concentrated on the airfoil of the grid wall 31. In view of this, the utilization efficiency of the airflow may be improved, and the grid wing 3 may provide a lift force that sufficiently resists the torque T of the main rotor 2.

FIG. 15 illustrates a schematic diagram of another grid wing with an external structure consistent with disclosed embodiments of the present disclosure. Referring to FIG. 15, in one embodiment, to block the airflow on the other side of the grid wing 3, the outer frame 32 may further include at least one second baffle 322. The second baffle 322 may be located on a side of the grid wing 3 close to the axis center 11 of the duct 1. A first end of the second baffle 322 may be connected to the outermost grid wall 31 of the grid wing 3, and a second end of the second baffle 322 may be arranged obliquely toward the inside of the grid wing 3. In view of this, the second baffle 322 disposed on the inner side of the grid wing 3 may prevent airflow from escaping from the inner side of the grid wing 3, which may further improve the utilization efficiency of the airflow. In one embodiment, the second end of the second baffle 322 may be suspended. In another embodiment, the second end of the second baffle 322 may be connected with any other suitable structure to improve the structural strength of the second baffle 322.

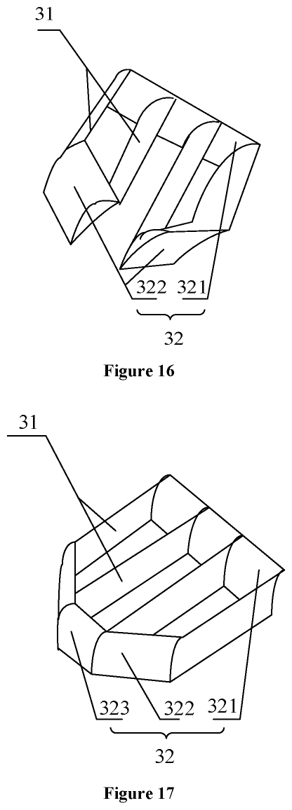

FIG. 16 illustrates a schematic diagram of another grid wing with an external structure consistent with disclosed embodiments of the present disclosure. Referring to FIG. 16, in one embodiment, the second end of the second baffle 322 may be connected to the grid wall on the inner side of the grid wing 3. In view of this, the two ends of the second baffle 322 may be connected to the grid wall 31, which may effectively improve the structural strength and enhance the structural reliability of the grid wing 3.

FIG. 17 illustrates a schematic diagram of another grid wing with an external structure consistent with disclosed embodiments of the present disclosure. Referring to FIG. 17, in one embodiment, the outer frame 32 may further include a third baffle 323. The third baffle 323 may be disposed at an end of the grid wall 31 close to the axis center 11 of the duct 1. The third baffle 323 may have a direction perpendicular to the grid wall 31, and the second end of the second baffle 322 may be connected to an end of the third baffle 323.

In addition, a quantity of the second baffles 322 may often be two, and the two second baffles 322 may be disposed on opposite sides of the grid wing 3 to ensure the force balance of the grid wall 31 in the grid wing 3. In one embodiment, the span length of the grid wing 3 may be in a range of approximately 40 mm-70 mm, a chord length thereof may be in a range of approximately 20 mm-70 mm, and an aspect ratio thereof may be approximately less than 3.5. Therefore, the aspect ratio may be substantially small compared with that of a traditional grid wing, which may reduce the overall size of the grid wing 3.

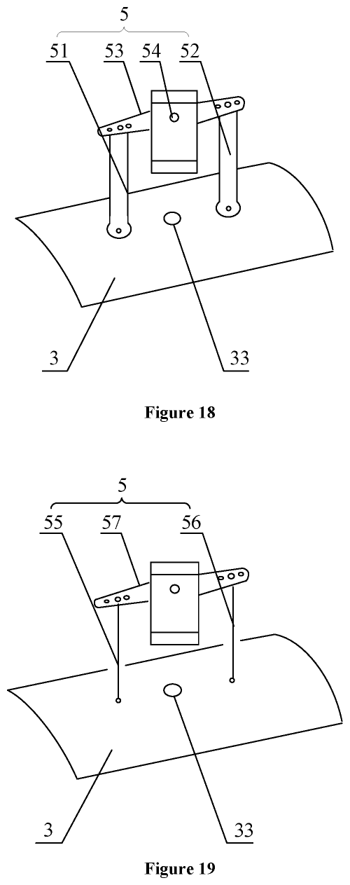

FIG. 18 illustrates a schematic diagram of a control mechanism of a grid wing consistent with disclosed embodiments of the present disclosure. Referring to FIG. 18, when the grid wing 3 is capable of rotating, to control the rotation of the grid wing 3 to perform the overall attitude adjustment of the propulsion device, the propulsion device may further include a control mechanism 5. The control mechanism 5 may be connected to the grid wing 3 for changing the rotation angle of the grid wing 3.

In one embodiment, the control mechanism 5 may use a preset instruction or a manual instruction to change the rotation angle of the grid wing. When the grid wing 3 turns to different angles, the direction of the lift force thereof may be changed accordingly, and the propulsion device may be caused to rotate and flip through the change of the torque. To achieve the control of the grid wing 3, the control mechanism 5 may also have various structural forms.

In one embodiment, the control mechanism 5 may include a steering gear. The steering gear may often be driven by a power source, e.g., a motor, and may rotate and swing when receiving an external control signal. In one embodiment, the steering gear may often include a first connecting rod 51, a second connecting rod 52, and a swingable swing rudder 53. A first end of the first connecting rod 51 and a first end of the second connecting rod 52 may be connected to different ends of the swing rudder 53, respectively. A second end of the first connecting rod 51 and a second end of the second connecting rod 52 may be connected to different sides of the grid wing 3 with respect to the rotation axis 33 of the grid wing 3, respectively. In view of this, the swing rudder 53, the first connecting rod 51, the second connecting rod 52 and the grid wing 3 may together form a parallelogram connecting rod mechanism. When the swing rudder 53 swings, two sides of the grid wing 3 with respect to the rotation axis 33 of the grid wing 3 may swing in synchronization with the swing rudder 53 driven by the first connecting rod 51 and the second connecting rod 52, and the airfoil surface of the grid wing 3 may be turned to different directions. In view of this, the steering mechanism may include a plurality of steering gears to correspondingly drive different grid wings 3, and each steering gear may correspond to one grid wing 3 to drive a corresponding grid wing 3 to rotate.

To enable the steering gear to rotate or swing, the control mechanism 5 may further include a driving motor 54 and a closed-loop controller (not illustrated). An output shaft of the driving motor 54 may be connected to the swing rudder 53 for driving the swing rudder 53 to swing. The closed-loop controller may be configured to control an output state of the driving motor 54. In one embodiment, the closed-loop controller may control the output power and output angle of the driving motor 54 according to feedback information, e.g., the swing state of the swing rudder 53, etc., such that the grid wing 3 may be adapted to the current airflow state, and may be capable of achieving normal control.

FIG. 19 illustrates a schematic diagram of another control mechanism of a grid wing consistent with disclosed embodiments of the present disclosure. Referring to FIG. 19, in another embodiment, the control mechanism 5 may further include a third connecting rod 55 and a fourth connecting rod 56. A first end of the third connecting rod 55 and a first end of the fourth connecting rod 56 may be fixedly disposed with respect to the duct 1. A second end of the third connecting rod 55 and a second end of the fourth connecting rod 56 may be connected to different sides of the grid wing 3 with respect to the rotation axis 33 of the grid wing 3, respectively. The lengths of the third connecting rod 55 and the fourth connecting rod 56 may be variable. In view of this, by changing the lengths of the third connecting rod 55 and the fourth connecting rod 56, the grid wing 3 may be driven to rotate in different directions to generate the lift force in different directions.

The lengths of the third connecting rod 55 and the fourth connecting rod 56 may be changed in a variety of different manners. In one embodiment, the third connecting rod 55 and the fourth connecting rod 56 may be composed of different connecting rod segments, and different connecting rod segments may achieve relative movement by a thread or a slide. Therefore, the overall length of the third connecting rod 55 and the fourth connecting rod 56 may change. In another embodiment, the third connecting rod 55 and the fourth connecting rod 56 may be made of a variable-length material. In certain embodiments, the lengths of the third connecting rod 55 and the fourth connecting rod 56 may be changed by a method known to those skilled in the art.

In one embodiment, when the third connecting rod 55 and the fourth connecting rod 56 are made of a variable-length material, the third connecting rod 55 and the fourth connecting rod 56 may be memory alloy parts. A length between two ends of a memory alloy part may change as the physical state of the memory alloy part changes. In view of this, the memory alloy part may be deformed by controlling the physical state of the memory alloy part to change the length of the memory alloy part. Therefore, the third connecting rod 55 and the fourth connecting rod 56 may pull the grid wing 3 to rotate. In one embodiment, the length of the third connecting rod 55 may increase and the length of the fourth connecting rod 56 may decrease to rotate the grid wing 3 toward the fourth connecting rod 56. In another embodiment, the length of the third connecting rod 55 may decrease and the length of the fourth connecting rod 56 may increase to rotate the grid wing 3 toward the third connecting rod 55, etc.

In one embodiment, the change in the physical state of the memory alloy part may include the following: a change in the force received by the memory alloy part, a change in the energized state of the memory alloy part, a change in a temperature of the memory alloy part, a change in a magnetic field in which the memory alloy part is located, or a change in the lighting condition on the memory alloy part, etc. Therefore, the memory alloy part may be deformed to change the length thereof by changing the applied force, energized state, temperature, magnetic field, or lighting condition, etc.

Further, the physical state of the memory alloy part may be automatically changed according to the environment in which the propulsion device is located. In one embodiment, when the propulsion device is in air, the memory alloy part may be deformed due to temperature drop to pull the grid wing to rotate. In another embodiment, the physical state of the memory alloy part may be changed by actively issuing external instructions.

In one embodiment, to change the physical state of the memory alloy part, the control mechanism 5 may further include a driver 57. The driver 57 may be configured to send a signal that is capable of changing the physical state of the memory alloy part to the third connecting rod 55 and the fourth connecting rod 56. The signal sent by the driver may often include a mechanical signal, an electrical signal, an optical signal, a magnetic signal, or a thermal signal, etc. The driver may be coupled to the memory alloy part by a contact connection or a non-contact connection, as long as the normal transmission of the signal is ensured.

In the disclosed embodiments, the propulsion device may include the duct, the main rotor, and at least two grid wings. The main rotor may be located in the duct and may be coaxially arranged with the duct. The main rotor may be configured to drive fluid to flow in the duct to generate power. The grid wings may be located on a side of the main rotor. The grid wing may have a plurality of grid walls spaced apart and extended along the axial direction of the duct. Two side edges of the predetermined cross section of each grid wall may have different shapes, and the two side edges of the predetermined cross section of each grid wall may generate the lift force under the pressure difference of the fluid flowing through the grid wing. The grid wing may be configured to form a torque opposite to the torque of the main rotor under the lift force. In view of this, through the shape of the grid wall of the grid wing, the torque of the lift force that is capable of balancing the torque of the main rotor may be generated under the pressure difference of the fluid, such that the aircraft may still maintain balance when a single rotor is used. Therefore, unstable attitude, e.g., rotation, of the propulsion device and the aircraft may be avoided, thereby improving the portability of the aircraft.

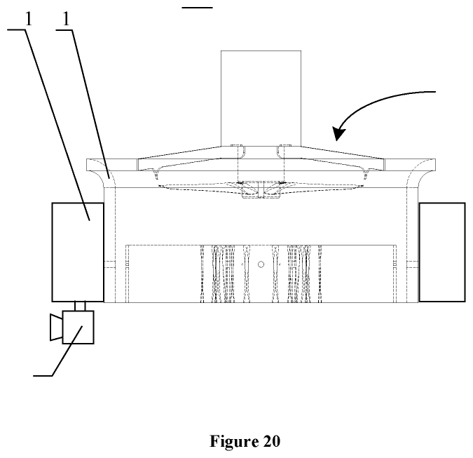

FIG. 20 illustrates a schematic diagram of a single-rotor unmanned aerial vehicle consistent with disclosed embodiments of the present disclosure. The single-rotor unmanned aerial vehicle in the present disclosure may use the propulsion device in any one of the above-disclosed embodiments to perform operations, e.g., flight and attitude adjustment in the air. Referring to FIG. 20, the single-rotor unmanned aerial vehicle 200 may include a body 201 and a propulsion device 100 described in the above-disclosed embodiments. The structure, function, and working principle of the propulsion device 100 may have been described in detail in the above-disclosed embodiments, and are not repeated herein.

In one embodiment, the single-rotor unmanned aerial vehicle 200 may include one propulsion device 100. Therefore, to ensure the balance of the center of gravity of the single-rotor unmanned aerial vehicle 200, the body 201 may often be connected up and down with or nested inside and outside the propulsion device 100 to avoid the single-rotor unmanned aerial vehicle to be tilted due to the shift of center of gravity.

Limited to the structure of the propulsion device 100, the body 201 of the single-rotor unmanned aerial vehicle 200 may often be connected to the duct 1 of the propulsion device 100. In one embodiment, the body 201 may be connected to one of an upper end of the duct 1, a lower end of the duct 1, and the outside of the duct 1. The body 201 may be provided with an on-board device, e.g., a battery, an electronic speed control, and a camera 202, etc.

In the disclosed embodiments, the single-rotor unmanned aerial vehicle may include the body and the propulsion device. The propulsion device may include the duct, the main rotor, and at least two grid wings. The main rotor may be located in the duct and may be coaxially arranged with the duct. The main rotor may be configured to drive fluid to flow in the duct to generate power. The grid wings may be located on a side of the main rotor. The grid wing may have a plurality of grid walls spaced apart and extended along the axial direction of the duct. Two side edges of the predetermined cross section of each grid wall may have different shapes, and the two side edges of the predetermined cross section of each grid wall may generate the lift force under the pressure difference of the fluid flowing through the grid wing. The grid wing may be configured to form a torque opposite to the torque of the main rotor under the lift force. In view of this, through the shape of the grid wall of the grid wing, the single-rotor unmanned aerial vehicle may generate the torque of the lift force that is capable of balancing the torque of the main rotor. Therefore, the single-rotor unmanned aerial vehicle may maintain balance when flying, and at the same time, may have a substantially small volume and weight, and may have a desired portability.

The above detailed descriptions only illustrate certain exemplary embodiments of the present disclosure, and are not intended to limit the scope of the present disclosure. Those skilled in the art can understand the specification as whole and technical features in the various embodiments can be combined into other embodiments understandable to those persons of ordinary skill in the art. Any equivalent or modification thereof, without departing from the spirit and principle of the present disclosure, falls within the true scope of the present disclosure.

What is claimed is:

1. A propulsion device, comprising:
a duct, a main rotor, and at least two grid wings, wherein:
the main rotor is located in the duct and is configured to drive fluid to flow in the duct to generate power,
the at least two grid wings are located on a side of the main rotor, and a grid wing comprises a plurality of grid walls spaced apart and extended along an axial direction of the duct,
two side edges of a predetermined cross section of each grid wall have different shapes to generate a lift force under a pressure difference of the fluid flowing through the grid wing, and
the grid wing is configured to form a torque opposite to a torque of the main rotor under the lift force.

2. The propulsion device according to claim 1, wherein:
the axial direction of the duct is located in the predetermined cross section of a grid wall.

3. The propulsion device according to claim 2, wherein:
the at least two grid wings are located between an axial center of the duct and an inner wall of the duct, and are arranged centro-symmetrically with respect to the axial center.

4. The propulsion device according to claim 3, further including:
a connection structure, wherein the connection structure comprises an axial body suspended over a position of the axis center of the duct, and the least two grid wings are located between the axial body and the inner wall of the duct.

5. The propulsion device according to claim 4, wherein:
the connection structure comprises a connection arm connected between the axial body and the duct.

6. The propulsion device according to claim 4, wherein:
one or more of the axial body and the inner wall of the duct are connected to the grid wing.

7. The propulsion device according to claim 4, wherein:
a rotation axis of the main rotor is connected to the axial body, and the main rotor is located between the axial body and the grid wing.

8. The propulsion device according to claim 2, wherein:
the grid wing is rotatably disposed in the duct, and
a rotation axis of the grid wing has a direction perpendicular to the axial direction of the duct.

9. The propulsion device according to claim 8, wherein:
a quantity of the at least two grid wings is three or more, and.
the three or more grid wings are located in a same plane perpendicular to the axial direction of the duct.

10. The propulsion device according to claim 9, wherein:
a quantity of the at least two grid wings is four, and
the four grid wings are mutually oppositely disposed in the duct with respect to the axis center of the duct, and are arranged in four mutually orthogonal directions in the plane, respectively.

11. The propulsion device according to claim 10, wherein:
the four grid wings comprise one or more pairs of grid wings that are capable of rotating with respect to the plane, to enable the lift force of the grid wing to have a direction having an angle with respect to the plane,
when the four grid wings comprise one pair of grid wings that are capable of rotating with respect to the plane, the propulsion device rotates around a first axis, and the first axis is parallel to a rotation axis of the grid wing, and
when the four grid wings comprise two pairs of grid wings that are capable of rotating with respect to the plane, the propulsion device rotates around the axis direction of the duct under a difference between the torque generated by the four grid wings and the torque of the main rotor.

12. The propulsion device according to claim 8, further including:
a grid wing driver for driving the grid wing to rotate to different angles.

13. The propulsion device according to claim 1, wherein:
the two side edges of the predetermined cross section of a grid wall each has a convex arc shape, and
the two side edges have different radians to enable the fluid flowing through the grid wing to generate a pressure difference on the two side edges.

14. The propulsion device according to claim 13, wherein:
the two side edges comprise a first edge and a second edge,
a convex direction of the first edge is the same as a rotation direction of the main rotor,
a convex direction of the second edge is opposite to the rotation direction of the main rotor, and
the first edge has a radian greater than the second edge.

15. The propulsion device according to claim 1, wherein:
the plurality of grid walls in each grid wing are arranged parallel to each other along the axial direction of the duct.

16. The propulsion device according to claim 15, wherein:
each grid wing comprises three or more grid walls that are arranged parallel to each other.

17. The propulsion device according to claim 1, wherein:
the plurality of grid walls in each grid wing are arranged obliquely with respect to a radial direction of the duct, and
the plurality of grid walls in each grid wing are staggered with each other.

18. The propulsion device according to claim 17, wherein:
the plurality of grid walls in each grid wing comprises a plurality of first grid walls arranged parallel to each other along a first direction, and a plurality of second grid walls arranged parallel to each other along a second direction,
the plurality of first grid walls and the plurality of second grid walls are staggered with each other, and
the first direction is different from the second direction.

19. The propulsion device according to claim 18, wherein:
the first direction is perpendicular to the second direction.

20. A single-rotor unmanned aerial vehicle, comprising:
a body and a propulsion device, wherein the propulsion device comprises:
a duct, a main rotor, and at least two grid wings, wherein:
the main rotor is located in the duct and is configured to drive fluid to flow in the duct to generate power,
the at least two grid wings are located on a side of the main rotor, and a grid wing comprises a plurality of grid walls spaced apart and extended along an axial direction of the duct,
two side edges of a predetermined cross section of each grid wall have different shapes to generate a lift force under a pressure difference of the fluid flowing through the grid wing, and
the grid wing is configured to form a torque opposite to a torque of the main rotor under the lift force.
